(19) United States
(12) Patent Application Publication
(10) Pub. No.: US 2011/0203093 A1
(43) Pub. Date: Aug. 25, 2011

(54) METHOD FOR RECONDITIONING BARRELS

(75) Inventor: Todd Dollinger, Salem, OR (US)

(73) Assignee: RE WINE BARRELS, LLC, Salem, OR (US)

(21) Appl. No.: 12/710,209

(22) Filed: Feb. 22, 2010

(51) Int. Cl. B23P 6/00; F24J 3/00; B27H 3/04

(52) U.S. Cl. 29/402.06; 432/224; 147/36

(57) ABSTRACT

A method of reconditioning barrels previously used in the storage of alcoholic beverages is disclosed. In particular, the barrels are exposed to heat at a controlled temperature well below the ignition point of wood in order to toast them in a manner favored by vintners and distillers. Apparatus for this controlled toasting process is disclosed. In addition, apparatus for the removal of a layer of wood from the inside of the barrels prior to toasting is also disclosed.

### BACKGROUND OF THE INVENTION

Wine and other alcoholic beverages have been aged in barrels for centuries. The wood of the barrels offers flavors which cannot be easily duplicated any other way, so that even modern producers, with modern chemistry available to assist them, use wooden barrels produced in much the same way as they have been produced historically: by hand, under the direction of skilled master coopers. However, in the modern age, both quality wood and skilled artisans to shape it into suitable watertight containers have become more scarce relative to the demand for properly aged spirits. A barrel suited for the production of good-quality wine or whiskey can cost in excess of $1,000. In addition, the environmental impact of constantly throwing away barrels and procuring new ones cannot be ignored by producers catering to a market which takes such issues as deforestation and landfill capacity quite seriously. Therefore, it is desirable for producers to find a way to extend the usefulness of their barrels beyond a single use.

There have been efforts in the past to recondition barrels for reuse in wine and spirit aging by removing saturated wood from the interior and “toasting” the barrels to simulate the changes to the interior surface caused by heat applied during the manufacturing process. To date, the results of this process have been unsatisfactory, and the quality of reconditioned barrels has remained below that of new stock. The makers of higher-quality beverages have therefore been unable to adopt reconditioning on a large scale while upholding their standards.

### BRIEF SUMMARY OF THE INVENTION

A new method of reconditioning previously used wine and spirit barrels is disclosed. In particular, heat is used to alter the chemical makeup of the wood, both to eliminate undesirable wastes from previous use and to provide a “toast” to the wood, allowing it to impart flavors to the wine or other spirits which are aged therein. The toasting process is carried on for an extended period of time, greater than is known in the prior art, and at a temperature below the ignition point of wood. This reduced temperature eliminates all possibility of scorching, and therefore also eliminates the need for efforts to prevent scorching, such as the application of water to the interior of the barrel, which has been used by the prior art. The extended time period allows for a proper degree of toasting despite lower temperatures. In addition, the extended toasting period permits the heat to penetrate deeper into the wood, which more thoroughly eliminates waste chemicals such as acetone, which are leached into the wood during the aging process.

Prior to toasting, a barrel may be scraped to remove wood saturated by the previously stored liquids, and to expose fresh wood still capable of imparting desirable flavors. This scraping is best accomplished by cutting against the grain to minimize the possibility of accidental gouging, which weakens the wood. While lathe-turning has been used in the past, a more even and controllable method, which is easily adapted to barrels of different sizes and profiles, is to mill the wood with a rotary cutter while the barrel is held substantially stationary. The barrel may then be rotated a small distance and another pass with the cutter made, until the entire interior has been scraped clean.

After the barrel has been scraped and toasted, the heads must be refitted. Typically, because the extended toasting process dries the barrel so thoroughly, causing shrinkage, the original hoops must be moved to a lower position on the barrel to hold the staves in a watertight position. In some cases, the hoops must be reduced in diameter. The heads must also be reduced in diameter and recrozed in order to fit.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a side elevation of a barrel scraping apparatus showing a barrel during placement on or removal from the scraping machine.

FIG. 2 is a section of the barrel scraping apparatus along line 2-2 in FIG. 1

FIG. 2A is a section of the barrel scraping apparatus along line 2A-2A in FIG. 2

FIG. 3 is a plan view of the barrel scraping apparatus in the process of scraping a barrel with part of the barrel cut away to show the sled which carries the cutting head and motor.

FIG. 3A is a sectional view along line 3A-3A in FIG. 3.

FIG. 4 is a plan view of the barrel scraping apparatus in the process of scraping a barrel with part of the barrel cut away.

FIG. 5 is a side elevation of the barrel scraping apparatus in the process of scraping a barrel with part of the barrel cut away showing the sled that carries the cutting head at the end of its travel.

FIG. 6 is a plan view of the barrel scraping apparatus in the process of scraping a barrel with part of the barrel cut away showing the sled that carries the cutting head at the end of its travel.

FIG. 7 is a detail of one part of the sled showing depth of cut adjustment.

FIG. 8 is a schematic wiring diagram showing the power supply and reversing switches which operate the cutting head motor and the motor which moves the sled.

FIG. 9 is a perspective view of the toasting apparatus showing a barrel in place in dashed lines.

FIG. 10 is a side elevation of the toasting apparatus showing a barrel in place for toasting partially cut away.

FIG. 11 is a plan view of the toasting apparatus.

FIG. 12 is a schematic wiring diagram of the temperature control and heating circuits of the toasting apparatus.

### DETAILED DESCRIPTION OF PREFERRED EMBODIMENT

A barrel 10 which has been used in the aging of wine or other alcoholic spirits suffers from several defects which prevent its easy reuse. To begin with, the wood on the inside surface is thoroughly saturated with liquid, and may, in some cases, have formed pockets or “blisters” of liquid. This wetness encourages the growth of microorganisms such as acetobacter which may impart off flavors or even leach toxins into anything subsequently stored in the barrel 10. Even after drying, the dried remnants may impart flavor, muddying the distinction between vintages. Further, any flavor or character which the wood itself might be expected to impart during aging has already passed into the now-bottled spirits, and is unavailable for subsequent batches. Finally, wine is well-known to leave a residue of acetone in the wood of barrels 10 used for aging. Acetone is both toxic and undesirable from a flavor standpoint.

Saturated wood may be removed by scraping it out with mechanical means. This may be accomplished by hand, as with a simple knife or plane, or by machine, as with planers or lathes. It has been found that cutting along the grain has the serious disadvantage of encouraging the wood to tear, resulting in gouges. Because the grain is not cut cleanly in the process, pieces of the grain tend to both pull loose from their moorings instead of severing and drive a cutting implement deeper into the wood, resulting in an inconsistent finish. Oak has an unusually “stringy” grain structure, but is also the material of choice for most wine barrels, exacerbating the problem. Blisters, described above, also contribute by presenting to a knife a space of low resistance followed by a thicker piece of wood which is more difficult to cut.

Scraping is therefore most usefully accomplished by making cross-grain cuts, in which a cutting implement movement is much less likely to be affected by the longitudinal grain pattern, and instead simply severs it. One possibility is lathe turning, in which the barrel is rotated against a stationary cutting tool. This has several disadvantages. First, a barrel which is not well balanced will tend to create vibration in the works, resulting in an inconsistent surface and possibly requiring excessively deep cuts. Second, the speed at which the barrel surface meets the stationary tool is limited by the speed at which the barrel can be rotated. This speed is in turn limited by the barrel's balance and the power available. Lower speeds tend to promote inconsistent surfaces by allowing a tool to “catch” the wood and gouge it. The problem is not as pronounced as in the case of cuts with the grain, but it persists. Third, it may be difficult to securely chuck a barrel into a lathe and true it to the axis of rotation. Improper truing promotes out-of-balance operation and uneven cutting, but balanced operation, when it is achievable at all, requires substantial time and labor to achieve. Fourth, a barrel's interior surface may already be somewhat uneven or out of round, creating many of the same problems as vibration or off-center mounting, even when mounting is perfectly accomplished.

A superior method of cutting is to use a cutting implement 12 rotated at high speed, such as a mill or router bit, which rotates about an axis almost parallel to the barrel axis 15, and moves it through a barrel 10 approximately parallel to barrel axis 15. In a preferred embodiment, the cutting motor 100 is mounted on sled 102, and connected by a chain 103 to the shaft 101 which turns cutting implement 12 at around 10,000 RPM. Other methods of transmitting driving force, such as belts or gears, are also possible. The barrel 10 itself is held substantially stationary while the sled 102 moves from end 16 to end 18. The high speed cross-grain cutting technique results in a cut which is highly uniform along its length and does not suffer from gouging, even when it encounters blisters. When one pass from end 16 to end 18 is complete, the sled 102 encounters a limit switch 104, which causes the sled 102 to reverse direction. The sled 102 also strikes actuator arm 130, which in turn pulls on actuator cable 128, rotating shaft 129, pushing a moving pawl 132 into cog 134. Cog 134 is connected to support rollers 107 by a support roller shaft 136 and support roller chain 138, so that rotating the cog causes all support rollers 107 to rotate in unison, which in turn causes the barrel to rotate. The shaft 129, moving pawl 132, and cog 134 are so dimensioned as to cause the barrel to rotate by approximately the width of the cut made by the cutting implement 12. A fixed pawl 133 prevents the barrel from rotating backward while the moving pawl 132 returns to its starting position, pulled that way by spring 135. After barrel rotation, the cutting implement 12 is moved from end 18 to end 16, cutting another portion of the saturated wood away, and encounters another limit switch 105 and another actuator arm 131, resulting in a second reversal and rotation of the barrel. This entire process is thereby automated to minimize the required labor. In a preferred embodiment, approximately 3/16″ of wood is removed during the scraping process.

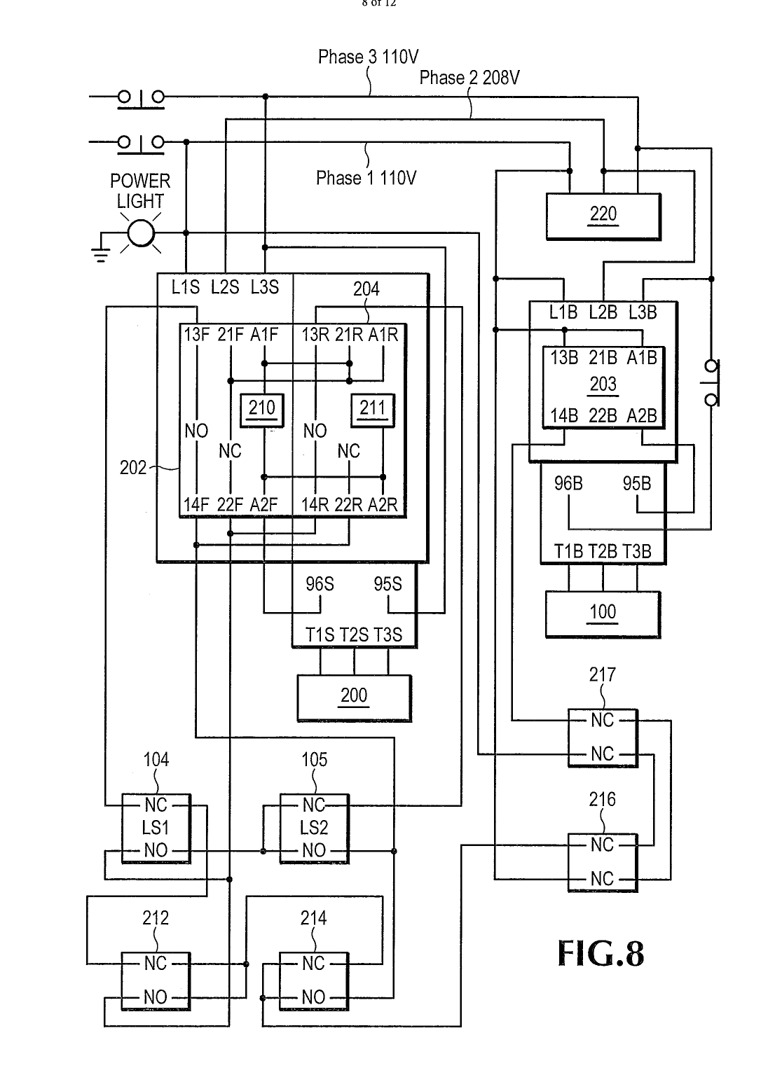

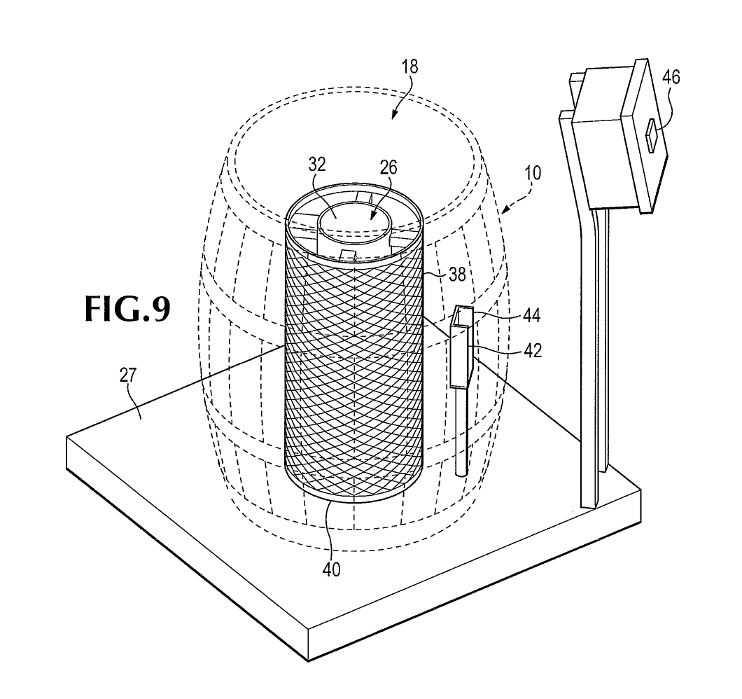

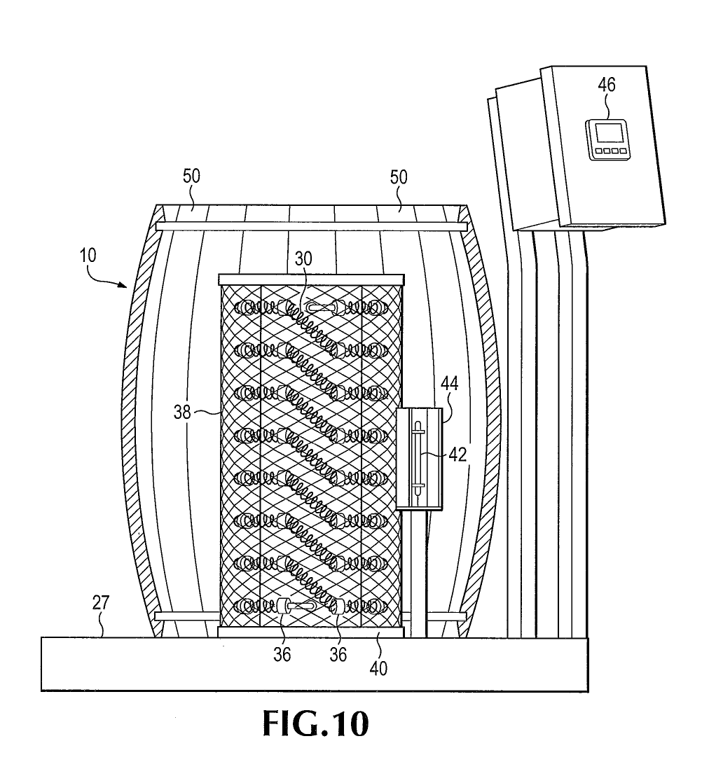

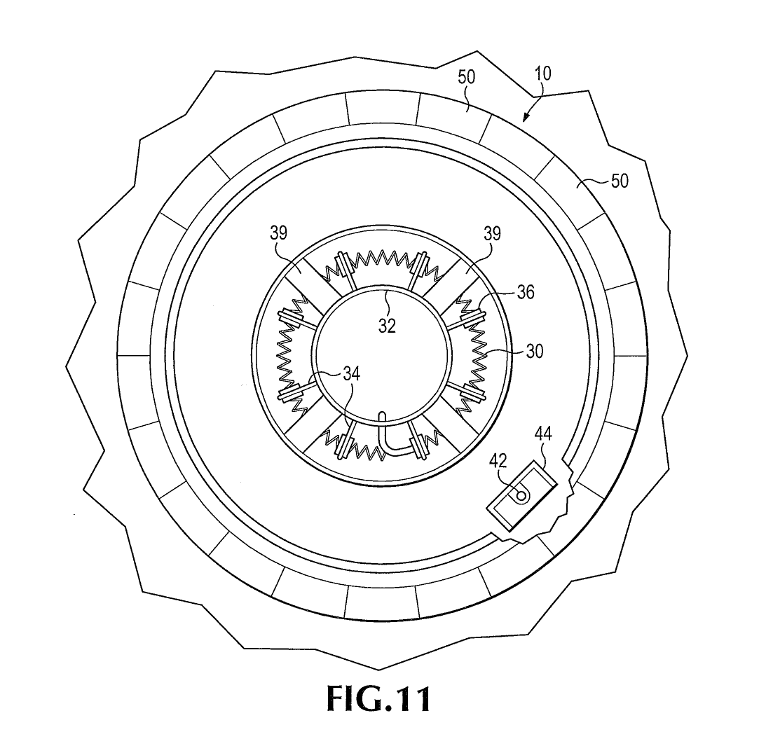

The sled 102 is moved by a sled motor 200, which is a 3-phase reversible motor. In a preferred embodiment, it is connected to the sled by sled chain 150. Preferably, the sled chain 150 has a “weak link” deliberately incorporated into its design somewhere along its length. In this way, if the sled 102 becomes stuck for any reason, the chain will break and prevent an overload of sled motor 200 or the power supply. This safety feature can also help prevent injury to operators. The wiring schematic by which the sled motor 200 is reversed is shown in FIG. 8, and is well known to electricians and those skilled in the art of industrial electrical motors. Two magnetic starters 202, 204 are connected to operate the sled motor 200. The forward starter 202 moves the sled in one direction, while the reverse starter 204 moves it in the opposite direction. In a preferred embodiment, these starters are model LC1D09 manufactured by Square D. The numbering of the terminals shown in FIG. 8 corresponds approximately to the labeling of terminals found on this model of starter. Power is connected to the terminals L1S, L2S, and L3S. Terminals L1S and L3S receive phase 1 and phase 3 power at 110 volts, 60 Hz, directly from the wall sockets, while terminal L2S receives phase 2 power from phase converter 220. The phases of power are well known to those skilled in the art of electrical wiring. The motor is in turn connected to the ports T1S, T2S, and T3S. Magnetic switches (not shown) within the starters connect the motor to the power lines appropriately to control its direction of rotation. The magnetic switches are operated by solenoid 210 connected to terminals A1F and A2F in starter 202, and solenoid 211 connected to A1R and A2R in starter 204. In addition to switching the power to the motor 200, the solenoids 210, 211 also control smaller switches within the starter. Terminals 13F and 14F are connected to a Normally Open (NO) switch, which closes when the magnetic switch in starter 202 is activated. Terminals 21F and 22F are part of a Normally Closed (NC) switch, which opens when the magnetic switch in starter 202 is activated. The same arrangement prevails in starter 204.

Terminals 95S and 96S are the terminals an overload disconnect switch, commonly known in the art as a “heater,” which cuts off power to the sled motor 200 in the event that the current exceeds the rated capacity of the heater. This operation is similar to that of an ordinary household circuit breaker.

When first energized, terminals A2F and A2R are both connected to phase 3 power. Current therefore tends to flow through the solenoid to terminals A1F and A1R, respectively, and then to terminals 21R and 21F, respectively. Because the switch at that point is NC, current tends to flow to terminals 22R and 22F. However, both 22F and 22R are connected to an open circuit. Push button limit switch 212 and start switch 214 are connected to phase 1 power, but both have NO connections to 22F and 22R, respectively. In addition, terminals 14R and 14F are also NO, and therefore current cannot flow. The magnetic switches remain unactivated and the sled motor 200 does not start.

When start switch 214 is depressed, current can flow from terminal 22R, through the switch, and to the phase 1 line. This permits current to flow through the solenoid of starter 202 (the path is phase 3 line to A2F, through the solenoid to A1F to 21R, through the NC switch to 22R, and then through the momentarily closed NO switch to the phase 1 line). With the magnetic switch activated, the NO switch between 13F and 14F closes, provided a current path that keeps it activated (the path is phase 3 line to A2F, through solenoid to A1F to 21R, through the NC switch to 22R, and then through the NO switch, which is closed by the magnetic switch, from 14F to 13F, then through the NC portion of limit switch 104, the NC portion of push button limit switch 212, through the NC portion of start switch 214, and then to the phase 1 line). In addition, the NC switch between terminals 21F and 22F is opened, which absolutely prevents any power from flowing through the solenoid portion of starter 204, preventing a conflict between the starters 202, 204.

The sled motor 200 runs in the forward direction until the sled 102 strikes limit switch 104. The NC portion of limit switch 104 opens, cutting power to the solenoid in starter 202, which cuts off power to the motor. At the same time, the NC switch between 21F and 22F closes, and is connected to the phase 1 line by the closing of the NO portion of limit switch 104. Current now flows from the phase 3 line to A2R to A1R through the solenoid, from A1R to 21F, through the NC switch to 22F, and through the temporarily closed NO portion of limit switch 104 and to the phase 1 line. The magnetic switch is activated, operating the motor in the reverse direction, closing the NO switch between 13R and 14R, and opening the NC switch between 21R and 22R. The sled motor 200 moves the sled away from limit switch 104, permitting it to return to its default state. Starter 204 is maintained in the on position by the flow of current from the phase 3 line to A2R, through the solenoid to A1R, then to 21F, through the NC switch to 22F, to 14R, then through the now-closed NO switch to 13R, and from 13R through the NC portions of limit switch 105, push button limit switch 212, starter switch 214, and then to the phase 3 line. In addition, because the NC switch between 21R and 22R is held open by the magnetic switch, starter 202 is incapable of attempting to cause sled motor 200 to move in the forward direction.

An identical transition process takes places when the sled 102 strikes limit switch 105. In this way, the sled 200 can operate indefinitely without the need for human intervention. It is also possible to start the motor's operation by depressing one of the limit switches 104, 105 instead of the start switch 214.

In a preferred embodiment, emergency stop button or “kill switch” is available, which cuts off power to the entire apparatus when struck. Two such kill switches 216, 217 are placed on the apparatus so that its operation may be easily halted.

The cutter motor is operated by a single starter 203. When power is applied, current flows from the phase 3 line, through overload terminals 95B and 96B, through terminal A2 and the solenoid to A1B, then from A1B to the phase 1 line. Terminals L1B, L2B, and L3B are connected to phase 1, 2, and 3 lines, respectively, and their power is transmitted to T1B, T2B, and T3B when the magnetic switch of starter 203 is activated.

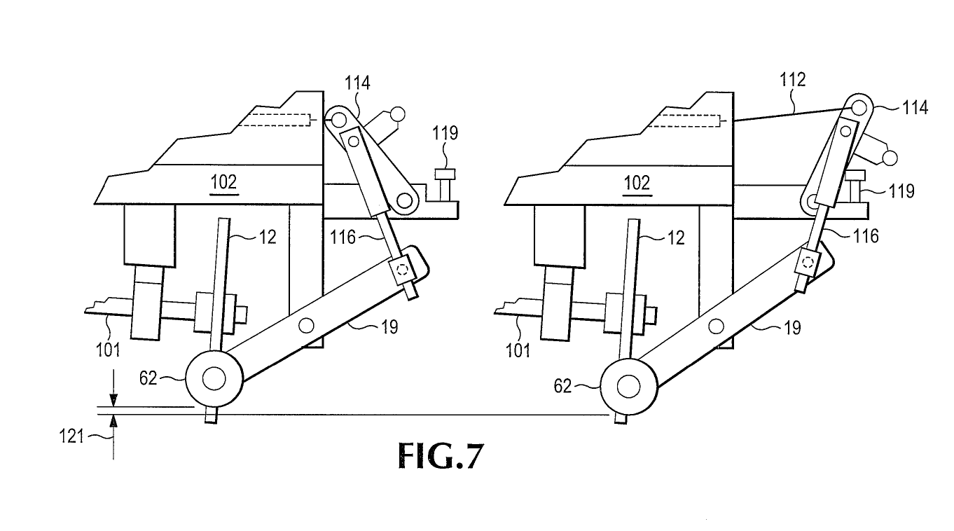

The sled 102 is mounted on an aim 108, which is free to rotate about a pivot 110. A counterweight 111 partially balances the weight of the arm 108 and the sled 102, so that the arm 108 has a tendency to move downward. During cutting, the cutting implement 12 is kept in contact with the barrel by guide arms 19, 20, which in turn are held a predetermined distance from the barrel surface by guide wheels 62, 63. The guide arm 19 is held at a predetermined position by the over-center lock mechanism comprising adjustment screws 116 and locking arm 114. The actual height is determined by the length of adjustment screw 116, and should be set before any cuts are made. By pulling or pushing adjustment cables 112 the locking arm 114 may be moved to either of two positions as shown best in FIG. 7. In the higher position, the locking arm 114 rests against the sled 102. In the lower position, the locking arm 114 rests against a stop 119, whose height determines the exact change in height 121. An mirror-image linkage comprising an adjustment cable 113, adjustment screw, locking arm, guide arm 20 and guide roller 63 operates on the other side of the sled 102 in the same way for the same purpose. This permits the guide arms 19, 20 to be moved approximately ⅛″ vertically relative to the cutting implement 12 during use, indicated in FIG. 7 by reference numeral 121, should such adjustment be necessary to account for irregularities in the barrel. It also permits the first cut in a barrel to be made deeper than subsequent cuts, and the final cut to be made shallower, without interruption. This is necessary because during the first cut, both guide wheels ride on an uncut barrel surface, while during subsequent cuts, one of the wheels rides on cut surface while the other rides on uncut surface. The final cut is then made with both guide wheels operating on previously cut surface, for which a shallower cut is indicated.

The limit switch 104 and actuator aim 130 are mounted on bracket 140, which is in turn connected to the arm 108 with bolt 142, which passes through a selected hole 144. Barrels 10 of different sizes may be accommodated by the selection of a different hole 144 for mounting of the bracket 140. It is essential that the limit switch 104 and actuator arm 130 be positioned to permit the cutting implement 12 to scrape the full length of barrel 10, but that the sled 102 be reversed before the guide wheels 62, 63 pass out of the barrel 10 and allow the arm 108 to fall.

The weight of arm 108 and sled 102 serve to keep the guide wheels 62, 63 in contact with the barrel. Other biasing means, such as springs, linear actuators, stepper motors and the like are also possible, but are absent in the preferred embodiment for simplicity. It is also possible to replace the guide aims 19, 20 with an alternative means of measuring distance, such as a laser rangefinder, and use active controls such as linear actuators or stepper motors to maintain an even depth of cut. Such a system is useful in a high-volume application because of its durability and potential for full automation, but is unnecessarily complicated for smaller volumes. The preferred embodiment permits barrels 10 of varying sizes and profiles to be scraped clean by a single apparatus with only minor adjustments being made between barrels 10. A barrel 10 need not be placed in the cutting machine with great precision, increasing throughput and decreasing labor.

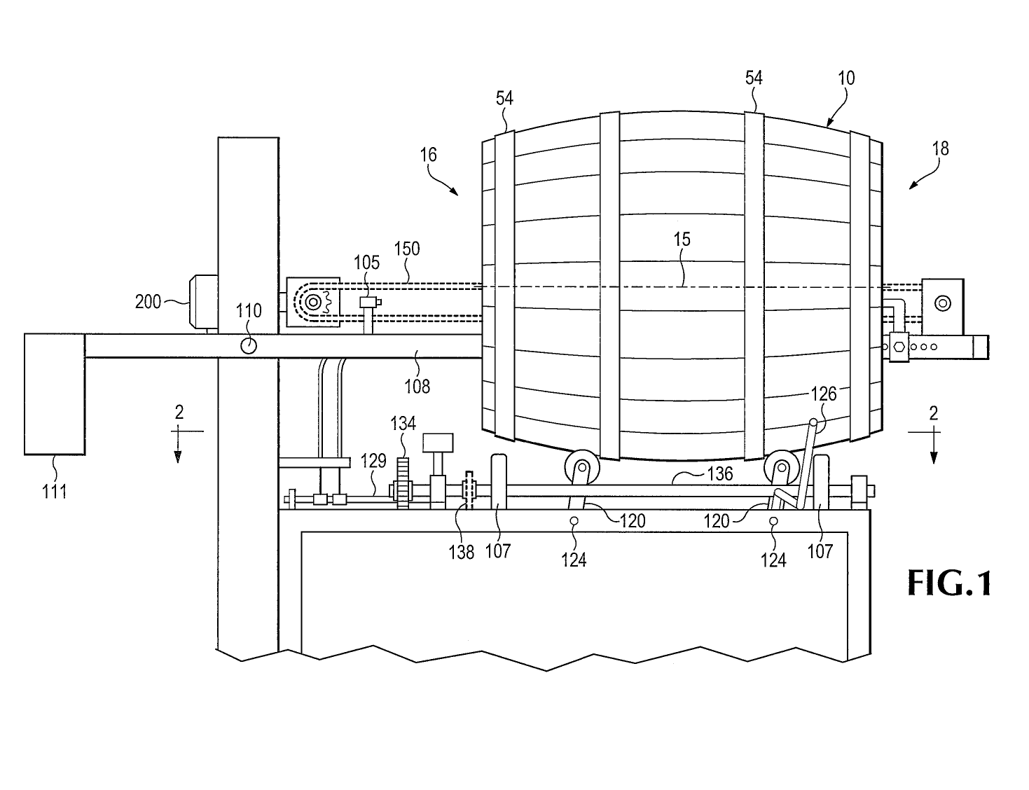

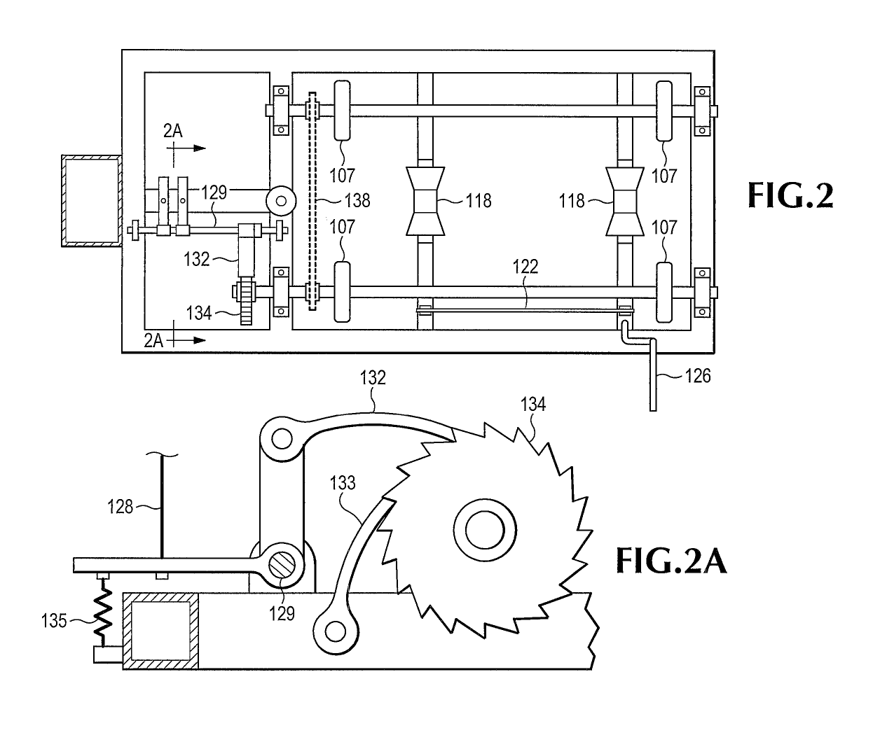

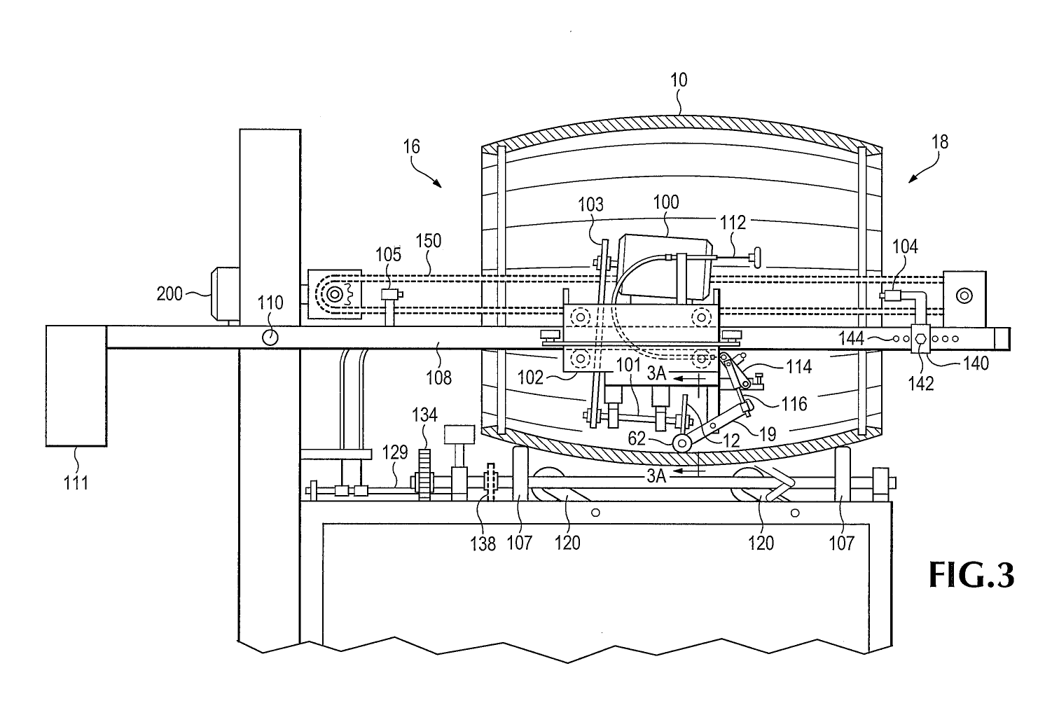

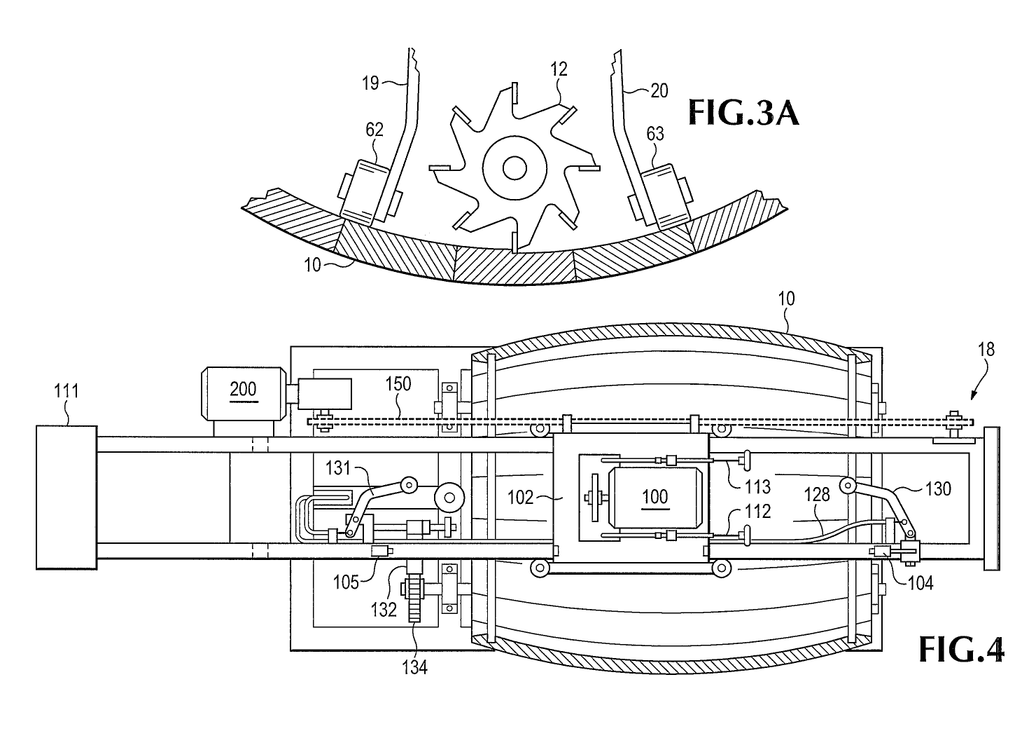

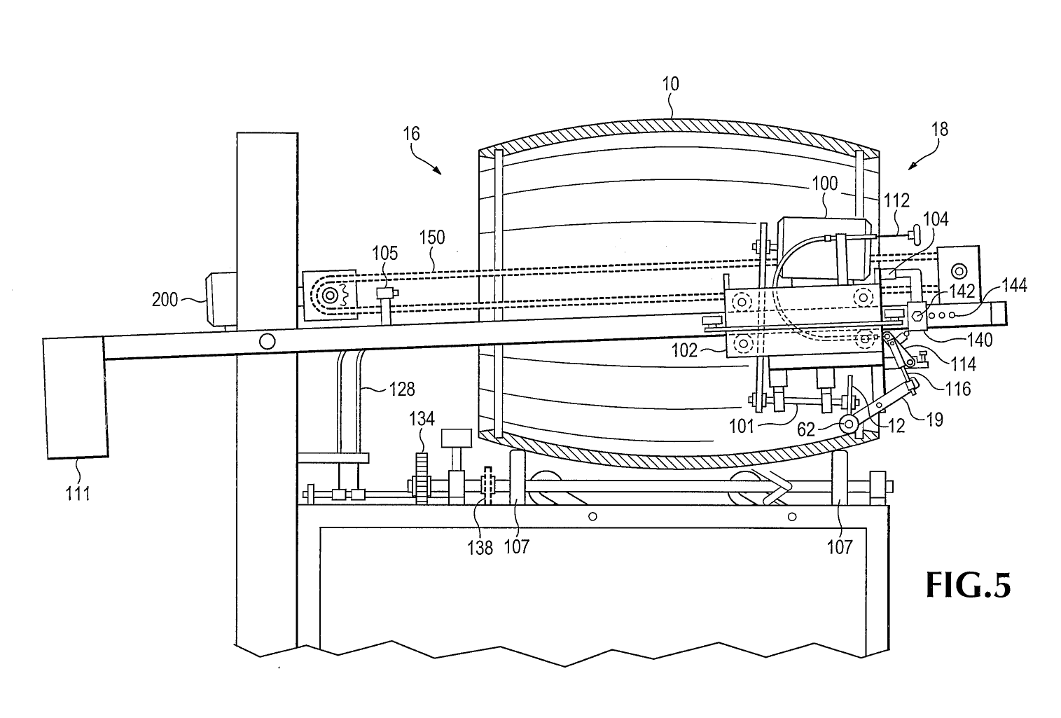

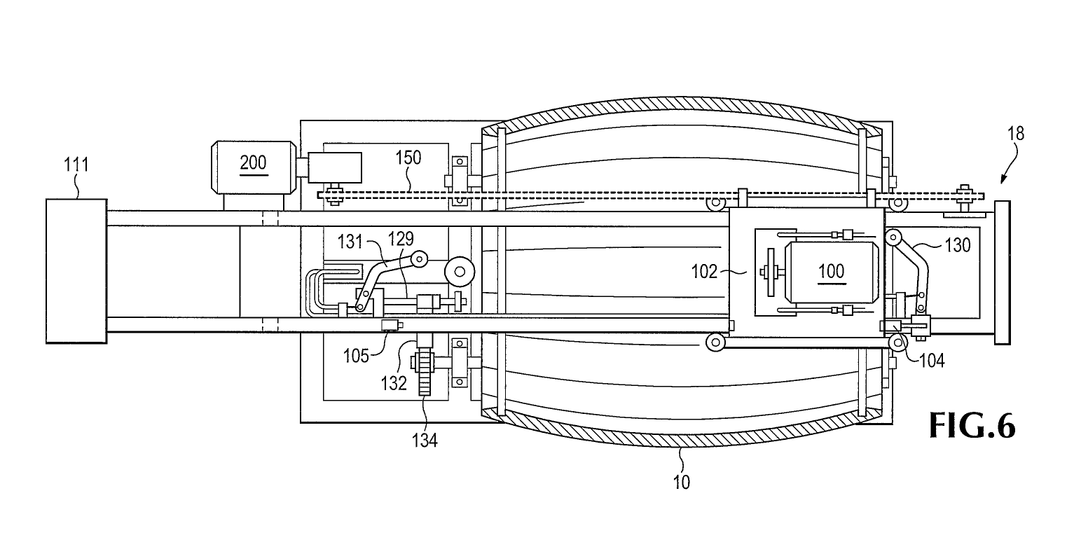

In a preferred embodiment, the placement and removal of barrels is facilitated by the use of guide rollers 118, which are carried on arms 120. These arms are connected by bar 122, and can rotate around pivots 124. When handle 126 is rotated upward, the guide rollers 118 pivot upward and lift the barrel 10 off of the support rollers 107, allowing the barrel 10 to roll on or off of the machine, as best shown in FIG. 1. When handle 126 is rotated downward, the guide rollers 118 move clear of the barrel 10 so that its rotation on support rollers 107 is unimpeded, as best shown in FIG. 3.

When a barrel 10 has been scraped, the exposed wood will be “raw,” in the sense that it will not have a carmelized surface which results from heating during the manufacturing process, and which is considered desirable for imparting flavor to stored liquids. However, the wood will nonetheless be inferior to truly raw wood because acetone from the spirits previously stored leaches into the wood considerably deeper than water, and will be present even when the visibly saturated wood has been removed. For proper flavor, it is necessary to both caramelize the surface and drive the acetone out, yielding a reconditioned barrel 10 which has all the characteristics of a new one.

To toast the interior of the barrel 10, the barrel, without heads, is placed over heating unit 26. One end 16 of the barrel rests on floor plate 27, or on a level surface under the heating unit 26. A lid is placed over the other end 18. Preferably, the heating element is electrically powered, although heat from natural gas or even wood flames are known to those skilled in the art. The heating element comprises wire 30, which in one embodiment is a 3450 W, 240 V, 14.4 A, 15.5 ohm, 41″ CWL, ¼″ ARB, loop end coil of 16 gauge heater wire, available from Process Heating Co., Inc., of Seattle, Wash., stretched to roughly ¼″ between coils and wrapped around a central form 32. Risers 34 on the central form 32 support insulators 36, which in turn support wire 30. Mesh screen 38 protects the wire 30 from damage and is connected to the central form 32 by arms 39 to prevent contact with the wire 30. All parts are preferably welded together, although any means of attachment capable of withstanding repeated heating, such as brazing, screws, or rivets, may be used. At the base of the mesh screen 38, a protective ring 40 is attached to the floor plate 27, preferably by welding, which prevents the heating unit 26 from damage when barrels 10 are shifted too close during placement or removal. Heating unit 26 should fit firmly within protective ring 40, but is preferably removable for repair. In a preferred embodiment, the overall height of the heating unit 26 is about 18 inches.

In one embodiment, the heating unit 26 draws a maximum of about 15 amps at 220 volts, single phase alternating current. The duty cycle at operating temperature is about 70 percent. This relatively low level of power results in a long heating time before full temperature is reached. Although the exact timing will depend on ambient temperature and humidity, it is not uncommon for a barrel to take a full hour to reach maximum temperature. Fast heating risks scorching of wood because infrared radiation can raise the temperature of the wood beyond that of the air inside the barrel 10. A rapid rise in temperature can also be difficult to control adequately, resulting in greater overshoot and greater risk of scorching. Preferably, the temperature of the heating element itself should be kept below 700° F.

The ignition point of wood is roughly 550° F., so to prevent scorching, toasting should be accomplished keeping the air inside the barrel below this temperature. Preferably, it should be in the range of 450-460° F. Using such a low temperature requires longer toasting times than are known in the prior art to achieve a full toast. However, in addition to eliminating the possibility of scorching the wood, a lower temperature and longer time permits the heat to penetrate more deeply into the wood, resulting in a deeper and more flavorful toast. Varying the time permits variations in the total toast level, which creates different flavors and allows a barrel to be conditioned to match the exact wishes of the vintner or distiller. A longer, slower toast permits finer distinctions between toast levels and is also more tolerant of slight variations in toasting time which may occur.

Using the equipment and conditions described above, a barrel 10 can be brought from cold to what winemakers call “a medium toast” in roughly two to three hours. This time will vary depending on the size and condition of the barrel 10, the thickness of the staves 50, the tendency of the staves 50 to separate during shrinkage, causing heat leaks, the ambient temperature and humidity, and the character of the original wood. Even for nominally identical barrels, time variations of 15 minutes are not unusual. It is helpful in practicing the method to keep a log book recording the pertinent details to assist in estimating the required time for future barrels and improving consistency. The barrel 10 is preferably monitored by a skilled worker and flipped from one end 16 to the other end 18 to achieve an even result of the appropriate darkness. Typically, this flipping occurs when about 60-65 percent of the expected total toasting time has passed. The worker may employ an infrared thermometer to monitor the temperature of the interior surface of the barrel 10. Preferably, this temperature will remain below 400° F. during the toast.

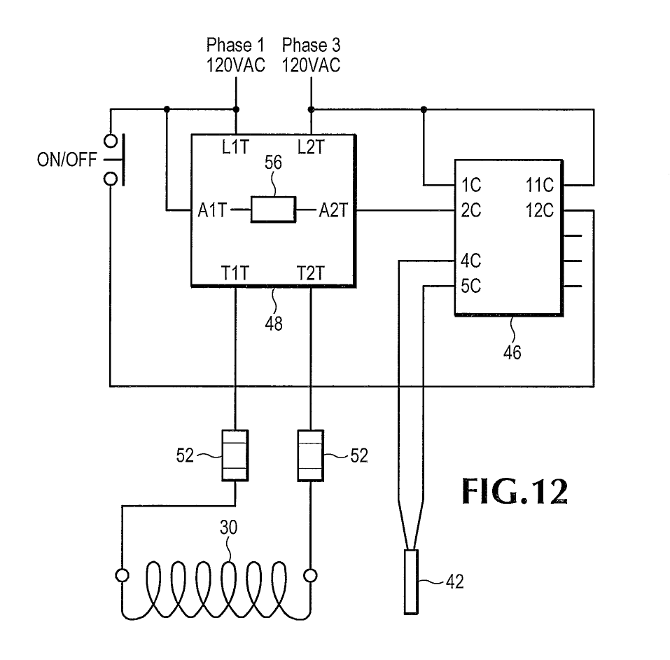

To control the interior temperature of the barrel 10 during toasting, the thermocouple 42 measures the air temperature inside the barrel, but other means of measurement, such as thermistors, are also possible. In one embodiment, thermocouple 42 is a J-type thermocouple. A heat shield 44 is preferably employed to prevent the infrared heating of thermocouple 42 by the heating unit 26. The signal is transmitted to thermostat 46. In one embodiment, the thermostat 46 is a LOVE® brand model 16C-3 temperature control. Thermostat 46 uses an electrical signal to turn magnetic switch 48 on or off in response to changes in temperature. FIG. 12 shows the wiring diagram for the thermostat system. Thermostat 46 is connected to 120 VAC power through terminals 11C and 12C, respectively, with 11C receiving phase 3 and 12C receiving phase 1. Phase 3 power is also provided to terminal 1C, to allow it to be switched through terminal 2C to control the duty cycle for the heater. Terminals 4C and 5C are connected to the J-type thermocouple 42. Phase 1 and Phase 3 power from the mains are connected to terminals L1T and L2T of the magnetic switch 48, in a preferred embodiment, a Siemens 45EG20AG. The magnetic switch 48 is controlled by a 120 VAC signal from terminal 2C. When the thermostat 46 connects terminal 2 to the phase 3 line, current flows through terminal A2T, through a solenoid 56, and to the phase 1 line through terminal A1T. The solenoid causes terminal L1T to be connected to terminal TIT, and terminal L2T to be connected to terminal T2T. Twenty amp fuses 52 protect the system from shorts. In practice, this combination functions as a variable duty cycle heater. The interior temperature of the barrel has been held steady to within about three degrees by this method. Other methods of heat control, such as the use of a variable transformer, are possible, but this method is preferable because of the simplicity and low cost of the control electronics.

Some prior art toasting methods have used water, often in the form of a fine mist, sprayed directly on the barrel 10 during toasting, to limit scorching and control the degree of toast. This is an unnecessary complication when the toasting is accomplished at a low temperature and is therefore preferably omitted.

A lid may be used to assist in retaining the heat inside the barrel. This lid is preferably not one of the heads which seal the ends of the barrel 10 while in use. Rather, it is preferably a sheet of metal which is unaffected by the toasting process. It need have no particular dimensions as long as it is capable of covering the end 18 of the barrel 10. The lid is periodically removed during the toasting process to check on the progress of the toast and to permit evaporated water and acetone, as well as other volatile wastes, to escape.

The toasting process is best carried out in a well-ventilated area. In addition to the considerable heat and some degree of acetone vapor generated, a proper toast generates substantial smoke, which is irritating to the eyes and lungs, and must therefore be exhausted efficiently.

The heads should also have saturated wood removed by a scraping process. Because the heads are often somewhat uneven, this is preferably accomplished by hand using a plane so that a minimum of wood can be removed. Mechanical means, such as power planers, are also possible, but will require the removal of more wood in order to capture all the low spots. This may result in significantly weakened heads. In one embodiment, the heads are not toasted. However, means for toasting heads are known in the art and may be employed if desired.

After a long, slow toast as described above, staves 50 typically experience substantial shrinkage. This requires that the hoops 54 be refitted to give a watertight result. For smaller degrees of shrinkage, the hoops may simply be remounted further away from the ends 16, 18 of the barrel 10 than they were when the barrel was new, giving a tighter fit. Sometimes, the shrinkage will be so great that the hoops must be resized to a smaller diameter, or replaced. Hoop making and sizing are well known in the art of cooperage.

Because stave shrinkage and the subsequent re-fitting of hoops results in a smaller diameter at ends 16, 18, the heads must also be resized and recrozed to fit properly. This is easily accomplished by trimming the heads with a router. A specially-cut router bit is then used to recroze the heads to match their original croze, which may vary somewhat between manufacturers. These methods are well known in the art.

After refitting of heads, barrels must be rehydrated with water and have their watertightness confirmed before valuable wine or other spirits can be aged in them. It is common in the barrel-making industry to partially fill a barrel with water and use air pressure to test for leakage. However, it is preferable to completely fill a barrel with water for the most realistic possible test. This filling also helps to soften the sharper edge of tannins developed during the toasting process. The barrels should preferably be left filled for at least six hours, but as many as 36 hours for full hydration and minimal chance of subsequent leaks. Water may be conserved by reuse. It should preferably not be used for more than three barrels before disposal to minimize the risk of biological cross-contamination and to prevent the tannin content of the water from becoming too high.

After barrels are filled and checked for leaks, they are preferably filled with sulfur dioxide gas to inhibit the growth of microorganisms before being transported to the user. This step may be omitted if preferred.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A method of reconditioning a wooden barrel, said barrel having two heads, comprising the steps of:
(a) removing the heads;
(b) placing the barrel on a surface with the barrel surrounding a heat source;
(c) placing a lid over at least part of a first end of the barrel;
(d) permitting the barrel to remain around the heat source at a predetermined temperature until an interior surface of barrel has darkened to a predetermined degree; and
(e) flipping the barrel over to place the first end on the surface;
(f) wherein said temperature is controlled at least in part by a thermostat.

2. The method of claim 1 wherein said thermostat controls temperature by varying the duty cycle of the heat source.

3. The method of claim 2 wherein said duty cycle is about 70% at maximum temperature.

4. The method of claim 1 wherein the barrel remains around the heat source for a total of at least 45 minutes.

5. The method of claim 1 wherein the barrel remains over the heat source for at total of at least 90 minutes.

6. The method of claim 1 wherein said temperature is measured in the air within the barrel and is no greater than 470 degrees Fahrenheit.

7. The method of claim 1 wherein said temperature is measured on the interior surface of the barrel and is no greater than 400 degrees Fahrenheit.

8. The method of claim 1 wherein said heat source is electrically powered.

9. The method of claim 8 wherein said heat source consumes approximately 15 amps of alternating current at 220 volts, single phase.

10. The method of claim 1 further comprising the step of removing a layer of wood from the inside of the barrel.

11. The method of claim 10 wherein said layer of wood is removed by a cutting action which moves against the grain.

12. The method of claim 11 wherein said layer of wood is removed from a substantially stationary barrel by a rotating cutting implement.

13. The method of claim 1 further comprising the step of recrozing the barrel heads to fit the end of the barrel.

14. The method of claim 13 further comprising the step of reducing the diameters of the heads to fit the reconditioned barrel.

15. The method of claim 1 further comprising the step of removing a hoop from said barrel and placing said hoop in a new position on said barrel.

16. The method of claim 1 further comprising the step of removing a hoop from said barrel and altering the diameter of said hoop.

17. The method of claim 1 further wherein the process is free of moisture other than ambient humidity.

18. The method of claim 1 wherein the barrel is thereby rendered substantially free of acetone.

19. The method of claim 1 further comprising the step of filling the barrel substantially full of water.

20. The method of claim 19 wherein the water is permitted to remain in the barrel for at least 6 hours.

21. A method of reconditioning a wooden barrel, said barrel having two heads, comprising the steps of:
(a) removing the heads;
(b) removing a layer of wood from the inside of the barrel;
(c) placing the barrel on a surface with the barrel surrounding a heat source;
(d) placing a lid over at least part of a first end of the barrel;
(e) permitting the barrel to remain around the heat source at a predetermined temperature until an interior surface of barrel has darkened to a predetermined degree;
(f) flipping the barrel over to place the first end on the surface, the barrel surrounding the heat source after flipping;
(g) removing a hoop from said barrel and placing said hoop in a new position on said barrel;
(h) reducing the diameters of the heads to fit the barrel; and
(f) filling the barrel substantially full of water.
